(19) United States
(12) Patent Application Publication
(10) Pub. No.: US 2021/0029049 A1
(43) Pub. Date: Jan. 28, 2021

(54) Low Latency DOCSIS Experience Via Multiple Queues

(71) Applicant: Harmonic, Inc., San Jose, CA (US)

(72) Inventors: Lior Assouline, Rishon Lezion (IL); Alex Muller, Pardes Hanna Karkur (IL); Nimrod Ben-Natan, San Jose, CA (US); Amir Leventer, Kfar Soba (IL)

(21) Appl. No.: 16/937,020

(22) Filed: Jul. 23, 2020

Related U.S. Application Data
(60) Provisional application No. 62/877,682, filed on Jul. 23, 2019.

(51) Int. Cl. H04L 12/823; H04L 12/863; H04L 12/861; H04L 29/06

(52) U.S. Cl. CPC H04L 47/32; H04L 69/16; H04L 49/90; H04L 47/6215

(57) ABSTRACT

Configurable levels of latency in data flows based on application type. An application type for a data flow is identified. The application type is one of a plurality of types that include a first type associated with applications that retransmit missing data packets not received by the intended recipient and a second type associated with applications that do not retransmit missing data packets not received by the intended recipient. Data packets of a data flow are enqueued onto a particular queue of two or more queues based on their identified application type. Each of the two or more queues store data packets of a different application type to be sent across a communication channel.

### CLAIM OF PRIORITY

This application claims priority to U.S. Provisional Patent Application Ser. No. 62/877,682, filed Jul. 23, 2019, entitled “Gaming Low Latency Flow Control,” the entire contents of which are hereby incorporated by reference for all purposes as if fully set forth herein.

### FIELD OF THE INVENTION

Embodiments of the invention relate to the latency of data exchanged via the Data Over Cable Service Interface Specification (DOCSIS) protocol by a cable service provider.

### BACKGROUND

Many users of residential broadband Internet connections experience latency at some point, which is a frustrating experience. For example, cable subscribers who play online games may occasionally experience latency while playing their game, which can negatively affect game performance. To avoid such frustrations, many cable subscribers pay for a high service tier in the hopes of avoiding latency in their Internet connection. However, cable subscribers report that they seldom see an improvement in latency when moving to a higher service tier. The ability to receive an improved experience in broadband Internet connections with less latency is a significant benefit to not only broadband subscribers, but also to cable operators who can more readily justify incremental service charges for improved quality of service.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a diagram of traffic exchanged between a cable modem (CM) and a cable modem termination system (CMTS) in accordance with the prior art;

FIG. 2 is a diagram of traffic exchanged between a CM and a CMTS using a dual queueing approach in accordance with an embodiment of the invention;

FIG. 3 is a block diagram of a dual queueing approach and a classifier for identifying application types associated with data flows in accordance with an embodiment of the invention;

FIG. 4 is a flowchart depicting the steps of providing configurable levels of latency for data flows in accordance with an embodiment of the invention; and

FIG. 5 is a block diagram that illustrates a computer system upon which software performing one or more of the steps or functions discussed above with reference to FIG. 4 may be implemented.

### DETAILED DESCRIPTION OF THE INVENTION

Approaches for providing configurable levels of latency for data flows are presented herein. In the following description, for the purposes of explanation, numerous specific details are set forth to provide a thorough understanding of the embodiments of the invention described herein. It will be apparent, however, that the embodiments of the invention described herein may be practiced without these specific details. In other instances, well-known structures and devices are shown in block diagram form or discussed at a high level to avoid unnecessarily obscuring teachings of embodiments of the invention.

### Communications Between a Cable Modem and a Cable Modem Termination System

Embodiments of the invention are directed towards advancements in how data flows are exchanged between cable modems (CMs) and cable modem termination system (CMTS). Embodiments enable the levels of latency experienced by data flows exchanged between CMs and the CMTS to be reduced to satisfy certain specified or configurable levels. As a result, cable operators may choose to offer a service embodying the invention to cable subscribers to provide those subscribers with certain guaranteed levels of quality of service, and more particularly, with service that exhibits a guaranteed lower level of latency.

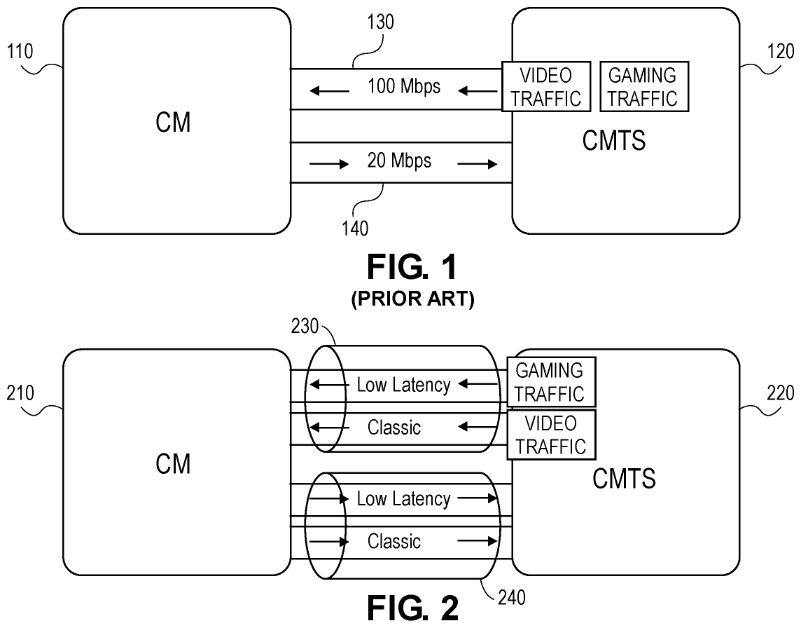

To better understand how embodiments of the invention operate, it will be helpful to appreciate how the existing art behaves. To that end, consider FIG. 1, which is a diagram of traffic exchanged between a CM 110 and a CMTS 120 in accordance with the prior art. While only one CM is depicted in FIG. 1 for simplicity, those in the art will readily appreciate that a plurality of CMs are actively communicating with any conventional CMTS.

A cable modem (CM), such as CM 110 of FIG. 1, refers to a physical device composed of hardware and software that is disposed within a dwelling of a cable subscriber. The purpose of the CM is to act as a connection point for Internet connectivity for the cable subscriber. During operation, each CM exchanges communication in the form a series of data packets (referred to herein as a data flow) with a CMTS. A CM may provide Internet connectively using a Data Over Cable Service Interface Specification (DOCSIS) protocol to exchange data packets facilitating the Internet connection between the CM and the CMTS.

A cable modem termination system (CMTS), such as CMTS 110 of FIG. 1, refers to one or more physical devices, composed of hardware and software, that are operated by a cable company for purposed of providing high speed data services, such as cable Internet, to cable subscribers.

Data that is sent from the CMTS to the CM is said to be sent in the downstream direction, while data that is sent from the CM to the CMTS is said to be sent in the upstream direction. For example, communication path 130 is in the downstream direction, and communication path 140 is in the upstream direction. It is common for the throughput capacity of a communication path to differ between the upstream direction and the downstream direction, e.g., downstream communication path 130 supports 100 Mbps, while upstream communication path 140 supports 20 Mbps. In a convention system, the capacity of the downstream direction far exceeds that of the upstream direction, as shown in the example of FIG. 1.

Latency may be experienced by any cable subscriber connecting to their CM 110 or by a cable operator at CMTS 120. The latency experienced at either CM 110 or CMTS 120 may be based on the aggregate behavior of both downstream communication path 130 and upstream communication path 140, as any delays in any leg of the roundtrip path of exchanged communications between both CM 110 and CMTS 120 contribute to the overall latency experienced at either end.

### Types of Application Behavior

Embodiments of the invention are concerned with providing improved performance by handling Internet traffic differently based on the application type of the application associated with the data flow. Application type, in this context, refers to a type of queuing behavior exhibited by the application used by the cable subscriber in the performance of exchanging data flows between that application and the CMTS. It is observed that queuing behaviour is an important factor in terms of the overall latency of an application and the overall variation in latency across the system.

Embodiments of the invention treat data flows from different application types differently. Any number of application types may be recognized and handled by embodiments of the invention. Two different application types will be discussed herein, namely the queue building application type and the non-queue building application type. For this reason, many illustrative embodiments will be discussed in relation to two different application types, but embodiments may subdivide any application type discussed herein into multiple subtypes or otherwise arrange application behavior into application types in any manner without deviating from the teachings of embodiments of the invention.

A first type of application is referred to herein as a queue building application. These types of applications send data from the CM to the CMTS at a rate which is typically faster than the communication path over which the data packets travel can currently support. Common examples of this type are applications which utilize TCP, UDP, or QUIC protocols in issuing traffic flows. UDP, TCP, and QUIC protocols use legacy flow control algorithms to manage congestion on the communication path.

Most network traffic today, by volume, is issued by a queue-building application. Non-limiting examples of queue-building applications are (a) video services such as YouTube and Netflix and (b) large file or application downloads.

A second type of application is referred to herein as a non-queue-building application. These types of applications issue data flows at a relatively low data rate and generally time their data packets in a way that does not cause queuing in the network. Common examples of this type of application include (a) non-capacity-seeking applications, such as multiplayer online games (such as Fortnite by Epic Games of Gary, and (b) IP-based communication applications (communication applications that communicate using the Internet Protocol (IP)), such as FaceTime or Skype. Non-queue-building applications issue data flows without any feedback on the queueing or delay in the network to rate limit the transition.

Queue building applications issue data flows that are not sensitive to latency, as the primary concern is reliability. If data packets of a queue building application are lost, transmission of the lost data packets occurs. In contrast, non-queue building applications issue data flows are sensitive to latency, and so if any data packets go missing or any not received, then there is no point in resending those missing or unreceived data packets, as any resent data packets will not be received in time to be useful by the recipient.

Anytime that the amount of aggregate traffic to be sent over a communication path exceeds its throughput capacity, it is necessary to delay data packets momentarily in a queue until the opportunity presents itself to send those data packets over the communication path. The magnitude of the delay induced by the queue (the “queueing delay”) directly contributes to the latency experienced over the communication path.

In the current state of the art, data packets for data flows associated with all application types are enqueued in a single queue in both the upstream direction and the downstream direction. For example, FIG. 1 illustrates data flows for video traffic (e.g., a queue-building application type) and for gaming traffic (a non-queue building application type) being processed in a single queue.

It is observed that data flows of queue-building application are typically the source of queuing delay, and data flows of non-queue-building applications typically suffer from the latency caused by the queue-building application data flows. The conflict between queue-building application data flows and non-queue-building application data flows can occur both within a single physical location serviced by a single cable modem (such as one family member gaming, while another family member using the same cable modem is watching a 4K Video stream or uploading a large file) or in a particular DOCSIS network segment or Serving Group.

### Processing Traffic Based on Associated Application Type

FIG. 2 is a diagram of traffic exchanged between CM 210 and CMTS 220 using a dual queueing approach in accordance with an embodiment of the invention. An embodiment of the invention may be implemented as software that executes upon one or both of CM 210 and CMTS 220. While only one CM is depicted in FIG. 2, embodiments of the invention may be implemented upon any number of cable modems that each communicate with a CMTS, such as CMTS 220.

The embodiment depicted in FIG. 2 allows for a consistent, lower latency performance over the prior art approach of FIG. 1. Advantageously, embodiments of the invention, as shall be discussed in greater detail below, may be implemented in software and delivered as a software update to a wide variety of cable modems, thereby allowing the benefits of the inventive approach to be used by a largest number of cable subscribers.

An aim of an embodiment is not to absolutely minimize the latency, but to deliver a cable broadband service which offers a consistent, low latency approach, which is critical to many consumer applications, such as gaming. Embodiments may do so without requiring any specific hardware in either the cable modem or the CMTS, as embodiments may be embodied entirely in software and delivered to a consumer's cable modem via a software update.

Embodiments make use a dual queueing implementation whereby traffic from queue-building and non-queue-building application flows is treated separately. The dual queueing approach is depicted in FIG. 2, which illustrates two different queues employed in both the downstream and the upstream direction. The application type associated with each data flow is identified, and thereafter data flows are enqueued in a queue associated with its identified application type. For example, as shown in FIG. 2, data packets carrying video traffic (such as from the Netflix application) are enqueued in a traditional or “classic” queue, while data packets carrying gaming traffic (such as from the game Fortnite) are enqueued in a separate ‘low latency’ queue.

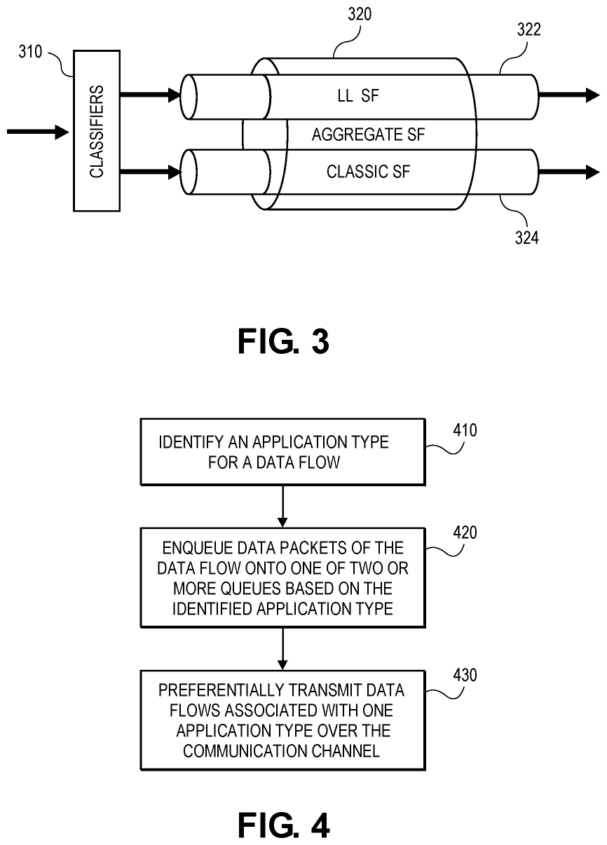

FIG. 3 is a block diagram of a dual queueing approach and classifier 310 for identifying application types associated with data flows in accordance with an embodiment of the invention. Classifier 310 may identify the application type associated with a data flow using a variety of different approaches. For example, in an embodiment, classifier 310 may employ a software configuration to identify an application type for a data flow having a known or easily discernible behavior pattern. Classifier 310 may also make use of an external classification/marking system in identifying an application type for a data flow. However, such an approach may not be responsive to new services and applications which require such a treatment but are not easily classified. It is contemplated that an embodiment may leverage the processing power and flexibility of the software-based CableOS® by Harmonic, Inc. of San Jose, Calif. to introduce a machine learning based approach to identifying those traffic types and flows which would specifically benefit from a low latency queuing approach and treating them accordingly. Various types of machine learning may be used, such as without limitation supervised learning.

The DOCSIS protocol may be used to assign a priority to a data flow. However, unfortunately it is difficult to treat data flows assigned to same DOCSIS priority level differently in the existing state of the art, even though it is often the case that data flows possessing the same DOCSIS priority level often having various levels of observed susceptibility to latency in the eyes of the cable subscriber. Advantageously, embodiments of the invention may use the identified application type of a data flow to process that data flow uniquely without dependence upon, or in relation to, any DOCSIS priority level which may be assigned thereto.

### Provide Discrete Levels of Latency in Data Flows

FIG. 4 is a flowchart depicting the steps of providing configurable levels of latency for data flows in accordance with an embodiment of the invention. The steps of FIG. 4 may be performed either at a CM in advance of sending data packets to the CMTS or at the CMTS in advance of sending those data packets to a single CM. In an embodiment, the steps of FIG. 4 may be performed at a CMTS in advance of sending data packets to two or more CMs.

The steps of FIG. 4 may be performed without any consideration of, or dependence upon, any personal information about a user associated with a data flow. Certain embodiments may consider what level of service of user has purchased from a cable service provider, but no personal information about the user, or any information that may be used to identify the user, need be considered for the proper operation of embodiments.

In step 410, an application type associated with a data flow is identified. The application type identified for the data flow may be one of any number of different application types. For purposes of providing a concrete example, an embodiment will be described in which the application type identified in step 410 is one of two different application types, namely a queue building application type and a non-queue building application type.

The queue-building application type is associated with applications that typically send or receive data flows at a faster rate than a communication channel traversed by the data flows can presently support. The non-queue-building application type is associated with applications that typically send or receive data flows no faster than the rate presently supported by the communication channel traversed by the data flows can presently support.

In an embodiment, classifier 310 may identify the application type of a data flow. Classifier 310 may identify the application type of a data flow using a variety of different mechanisms, such as but not limited to using one or more known behavior patterns for data flows of one or more application types, using a configuration maintained by the cable modem, using an external classification or marking system, or using machine learning techniques, such as but not limited to supervised learned. Cloud based games and online gaming (most of which are using the same engine) have similar traffic behavior. By analyzing traffic parameters (such as protocols, rate, avg packet size, burstiness, and the like) as features to train a machine learning algorithm, embodiment may cluster online gaming data flows and differentiate them from any other traffic.

In an embodiment, classifier 310 may identify the application type of a data flow without inspecting or relying upon any priority assigned using or identified by the Data Over Cable Service Interface Specification (DOCSIS) protocol.

In step 420, data packets of the data flow are enqueued to a particular queue within the cable subscriber's DOCSIS Service Flow based on the identified application type for that data flow. Each of said two or more queues store data packets of a different application type to be sent across the communication channel. Doing so ensures that only those specific data flows which would benefit are proactively moved to the ‘low latency’ queue.

For example, FIG. 2 depicts two different queues, namely a queue labeled ‘low latency’ and another queue labeled ‘classic.’ In an illustrative example of performing step 420, data flows identified as a non-queue-building applications type (such as data flows of the online game Fortnite) may be enqueued in the ‘low latency’ queue, while data flows identified a queue-building applications type (such as data flows of streaming service Netflix) may be enqueued in the ‘classic’ queue.

In step 430, data flows associated with non-queue-building applications are preferentially transmitted over the communication channel so that data flows associated with non-queue-building applications possess a smaller magnitude of latency than data flows associated with the queue-building applications. In this example, data flows associated with the online game Fortnite would be preferentially transmitted over the communication channel over data flows associated with the streaming service Netflix.

Once classifier 310 that resides at a cable modem identifies a data flow as a particular application type, classifier 310 creates an US Service Flow on the Cable modem so that upstream traffic of low latency sources will go through similar separate service flow on the upstream. For example, FIG. 2 depicts a separate ‘low latency’ queue and ‘classic’ queue within both downstream Service flow 230 and upstream Service flow 240; when downstream Service flow 230 is created such that it comprises a separate ‘low latency’ queue and ‘classic’ queue, upstream Service flow 240 will be created contemporaneously with similar queueing structure. An auto-detection mechanism will clean up resources and service flows once low latency sources/games are no longer active.

Embodiments may be further optimized by ensuring that only those cable subscribers with an appropriate ‘low latency’ or ‘gaming’ subscription would be permitted to benefit from the approach of FIG. 4. Thus, such an implementation could positively benefit those cable subscribers with an advanced ‘gaming’ or ‘low latency’ subscription and be responsive even to new service types or data flows which are not classified in advance via the cable modem configuration.

Embodiments require no specific hardware to be present at either the Cable Modem or the CMTS. Embodiments may be implemented using currently deployed Cable Modems and are not limited to advanced DOCSIS 3.1 devices. Embodiments are fully compatible with DOCSIS 2.0 onwards.

Embodiments of the invention allow the CMTS operator to offer a differentiated low latency ‘gaming’ service to their high tier customers who wish to experience latency in their broadband Internet access. Such a low latency approach also has benefits for other services such as Virtual Reality Video and the backhaul of traffic to 5G base stations.

### Implementing Mechanisms

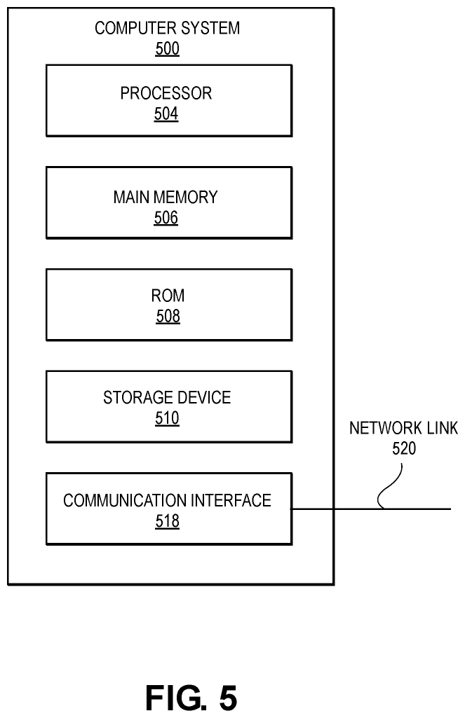

FIG. 5 is a block diagram that illustrates a computer system 500 upon which software performing one or more of the steps or functions discussed above with reference to FIG. 4 may be implemented. Physical components of cable broadband service network, such as a CMTS or a CM, may be implemented, in whole or in part, upon a computer system as shown in FIG. 5. Computer system 500 may correspond to either Commercial-Off-The-Shelf (COTS) computer hardware or special-purpose hardware.

In an embodiment, computer system 500 includes processor 504, main memory 506, ROM 508, storage device 510, and communication interface 518. Computer system 500 includes at least one processor 504 for processing information. Computer system 500 also includes a main memory 506, such as a random-access memory (RAM) or other dynamic storage device, for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device for storing static information and instructions for processor 504. A storage device 510, such as a magnetic disk or optical disk, is provided for storing information and instructions.

Embodiments of the invention are related to the use of computer system 500 for implementing the techniques described herein. According to one embodiment of the invention, computer system 500 may perform any of the actions described herein in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

The term “non-transitory machine-readable storage medium” as used herein refers to any non-transitory tangible medium that participates in storing instructions which may be provided to processor 504 for execution. Note that transitory signals are not included within the scope of a non-transitory machine-readable storage medium. A non-transitory machine-readable storage medium may take many forms, including but not limited to, non-volatile media and volatile media. Non-volatile media includes, for example, optical or magnetic disks, such as storage device 510. Volatile media includes dynamic memory, such as main memory 506.

Non-limiting, illustrative examples of machine-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a network link 520 to computer system 500.

Communication interface 518 provides a two-way data communication coupling to a network link 520 that is connected to a local network. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through a local network to a host computer or to data equipment operated by an Internet Service Provider (ISP).

Computer system 500 can send messages and receive data, including program code, through the network(s), network link 520 and communication interface 518. For example, a server might transmit a requested code for an application program through the Internet, a local ISP, a local network, subsequently to communication interface 518. The received code may be executed by processor 504 as it is received, and/or stored in storage device 510, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent modification. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. One or more non-transitory computer-readable storage mediums storing one or more sequences of instructions for providing configurable levels of latency for data flows, which when executed, cause:
identifying an application type for a data flow, wherein the application type is one of a plurality of types that include a first type and a second type,
wherein said first type is associated with a first set of applications that retransmit missing data packets not received by the intended recipient, and
wherein said second type is associated with a second set of applications that do not retransmit missing data packets not received by the intended recipient; and
enqueueing data packets of said data flow onto a particular queue of two or more queues based on said identified application type, wherein each of said two or more queues store data packets of a different application type to be sent across the communication channel.

2. The one or more non-transitory computer-readable storage mediums of claim 1, wherein said first type is associated with queue-building applications, wherein said second type is associated with non-queue-building applications, and wherein execution of the one or more sequences of instructions further causes:
preferentially transmitting data flows associated with non-queue-building applications over the communication channel so that data flows associated with non-queue-building applications possess a smaller magnitude of latency than data flows associated with the queue-building applications.

3. The one or more non-transitory computer-readable storage mediums of claim 1, wherein data flows assigned the same Data Over Cable Service Interface Specification (DOCSIS) priority experience different levels of latency based upon which one of the two or more queues their data packets are enqueued.

4. The one or more non-transitory computer-readable storage mediums of claim 1, wherein said identifying is performed, at least in part, using one or more supervised learning techniques performed upon one or more other data flows other than said data flow.

5. The one or more non-transitory computer-readable storage mediums of claim 1, wherein said identifying is performed, at least in part, using one or more known behavior patterns for data flows of one or more application types.

6. The one or more non-transitory computer-readable storage mediums of claim 1, wherein said identifying is performed, at least in part, using one or more of a configuration, an external classification or marking system, or machine learning.

7. The one or more non-transitory computer-readable storage mediums of claim 1, wherein said identifying is performed without inspecting or relying upon any priority assigned using or identified by the Data Over Cable Service Interface Specification (DOCSIS) protocol.

8. The one or more non-transitory computer-readable storage mediums of claim 1, wherein data packets of said data flow are enqueued onto the particular queue at a cable modem and sent over the communication channel to a Cable Modem Termination System (CMTS).

9. The one or more non-transitory computer-readable storage mediums of claim 1, wherein data packets of said data flow are enqueued onto the particular queue at a Cable Modem Termination System (CMTS) and sent over the communication channel to a Cable Modem.

10. The one or more non-transitory computer-readable storage mediums of claim 1, wherein (a) identifying the application type for the data flow and (b) enqueueing the data packets of said data flow onto the particular queue are both performed without consideration of any personal information about a user associated with said data flow.

11. The one or more non-transitory computer-readable storage mediums of claim 1, wherein said first set of applications include applications that use one or more of User Datagram Protocol (UDP), Transmission Control Protocol (TCP), and Quick UDP Internet Connection (QUIC) protocol.

12. The one or more non-transitory computer-readable storage mediums of claim 1, wherein said second set of applications include one or more of: multiplayer online games and IP-based communication applications.

13. The one or more non-transitory computer-readable storage mediums of claim 1, wherein said data flow corresponds to a download performed over the Internet, and wherein the data flow is identified as being the first type, and wherein the data flow experiences a greater magnitude of latency than data flows identified as being the second type.

14. The one or more non-transitory computer-readable storage mediums of claim 1, wherein said data flow conforms to Data Over Cable Service Interface Specification (DOCSIS) protocol version 2.0 or any subsequent version thereof.

15. The one or more non-transitory computer-readable storage mediums of claim 1, wherein said two or more queues each store data packets exchanged with a single Cable Modem (CM).

16. The one or more non-transitory computer-readable storage mediums of claim 1, wherein said two or more queues each store data packets exchanged with two or more Cable Modems (CMs).

17. An apparatus for providing configurable levels of latency for data flows, comprising:
one or more processors; and
one or more non-transitory computer-readable storage mediums storing one or more sequences of instructions, which when executed, cause:
identifying an application type for a data flow, wherein the application type is one of a plurality of types that include a first type and a second type,
wherein said first type is associated with a first set of applications that retransmit missing data packets not received by the intended recipient, and
wherein said second type is associated with a second set of applications that do not retransmit missing data packets not received by the intended recipient; and
enqueueing data packets of said data flow onto a particular queue of two or more queues based on said identified application type, wherein each of said two or more queues store data packets of a different application type to be sent across the communication channel.

18. The apparatus of claim 17, wherein data flows assigned the same Data Over Cable Service Interface Specification (DOCSIS) priority experience different levels of latency based upon which one of the two or more queues their data packets are enqueued.

19. A method for providing configurable levels of latency for data flows, comprising:
identifying an application type for a data flow, wherein the application type is one of a plurality of types that include a first type and a second type,
wherein said first type is associated with a first set of applications that retransmit missing data packets not received by the intended recipient, and
wherein said second type is associated with a second set of applications that do not retransmit missing data packets not received by the intended recipient; and
enqueueing data packets of said data flow onto a particular queue of two or more queues based on said identified application type, wherein each of said two or more queues store data packets of a different application type to be sent across the communication channel.

20. The method of claim 19, wherein data flows assigned the same Data Over Cable Service Interface Specification (DOCSIS) priority experience different levels of latency based upon which one of the two or more queues their data packets are enqueued.
